(19) United States
(12) Patent Application Publication
(10) Pub. No.: US 2010/0088711 A1
(43) Pub. Date: Apr. 8, 2010

(54) CLAMPING DEVICE AND SPINDLE MOTOR INCLUDING THE SAME

(76) Inventor: Ho Eop Yoon, Gyeonggi-do (KR)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/574,453

(22) Filed: Oct. 6, 2009

(30) Foreign Application Priority Data
Oct. 7, 2008 (KR) 10-2008-0098066

(51) Int. Cl. G11B 17/04

(52) U.S. Cl. 720/604; G9B/17.013

(57) ABSTRACT

A clamping device of a spindle motor is so formed as to allow an inclination supporting a disk by being in contact with an inner upper circumferential edge of the disk mounted on a rotor yoke to form an angle of 52°˜55°, whereby the disk is not separated from the clamping device by a shock of less than a predetermined size, thereby enhancing the reliability of product.

### CROSS-REFERENCE TO RELATED APPLICATION

This application claims the benefit under 35 U.S.C. §119 of Korean Application No. 10-2008-0098066, filed Oct. 7, 2008, which is hereby incorporated by reference in its entirety.

### BACKGROUND

The present disclosure relates to a clamping device and a spindle motor including the same.

An optical disk device is a device for optically inputting data in or outputting data from an optical disk. The optical disk device typically includes an optical pickup for accessing data of an optical disk, a spindle motor for rotating the optical disk and a feeding motor for moving the optical pickup to an inner periphery or an outer periphery direction of the optical disk.

A spindle motor is installed inside an optical disk drive, and performs a function of rotating a disk to enable an optical disk pickup to read data recorded on the disk. A slim-type spindle motor used for a notebook is installed with a clamping device for supporting a disk.

### BRIEF SUMMARY

The present disclosure intends to provide a clamping device capable of increasing a withdrawal force to improve reliability of product, and a spindle motor including the clamping device.

In one general aspect of the present disclosure, a case rotating with a rotation shaft of a spindle motor; a plurality of arms provided at the case for supporting a disk and clamping the disk on the case, and having an inclination at a portion facing the disk; and an elastic member installed inside the case for elastically supporting the arms toward an radial exterior direction of the case, wherein an angle formed by an inclination of the arm and the disk is in the range of 52°˜55°.

A clamping device of a spindle motor comprising: In some exemplary embodiments, the arm may incline at as much an angle as to prevent the disk from being withdrawn from the arm when the disk is installed at the case and the arm to provide a shock force of a predetermined size.

In another general aspect of the present disclosure, a spindle motor comprises: a rotation shaft; a stator arranged about the rotation shaft and having a core wound with coil; a rotor yoke rotating around the core and whose center is press-fitted into the rotation shaft for mounting a disk thereon and for rotating by wrapping the disk; and a clamping device provided with a plurality of arms for clamping the disk and supporting the disk mounted on the rotor yoke, wherein the arm is provided with an inclination having an angle as large as 52°˜55° from the disk.

### BRIEF DESCRIPTION OF DRAWINGS

FIG. 1 is a cross-sectional view illustrating a clamping device of a spindle motor as an imaginary comparative exemplary embodiment for comparing with the present disclosure.

FIG. 2 is a cross-sectional view illustrating a spindle motor with a clamping device according to an exemplary embodiment of the present disclosure.

FIG. 3a is a perspective view of a clamping device and a rotor yoke illustrated in FIG. 2.

FIG. 3b is an enlarged view of arm illustrated in FIG. 3a.

FIG. 4 is a cross-sectional view of line “A-A” of FIG. 3a illustrating a clamping device coupled to a rotor yoke.

### DETAILED DESCRIPTION

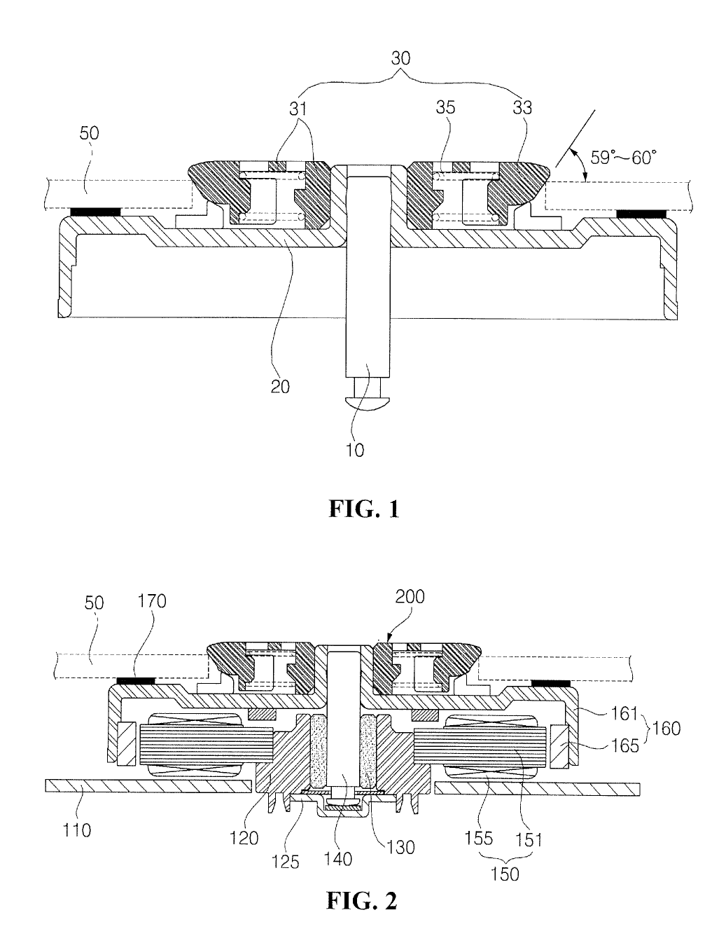

FIG. 1 is a cross-sectional view illustrating a clamping device of a spindle motor as an imaginary comparative exemplary embodiment for comparing with the present disclosure.

Referring to FIG. 1, a rotatable rotation shaft 10 is installed with a rotor yoke 20 mounted with a disk 50, the rotor yoke 20 simultaneously rotating with the rotation shaft 10. A portion of the rotor yoke 20 coupled to the rotation shaft 20 is brought into contact with an inner upper edge of the disk 50, where a clamping device 30 supporting the disk 50 is installed.

The clamping device 30 includes a substantially cylindrical case 31 centrally coupled to the rotor yoke 20, a plurality of arms 33 and a plurality of claws (not shown) respectively formed at a lateral surface of the case 31, and an elastic member elastically supporting the arm 33 toward an radial outer direction of the case 31.

The clamping device 30 illustrated in FIG. 1 is configured in such a manner that an inclination of arm 33 for preventing the disk 50 from being disengaged by being in contact with an inner upper edge of the disk 50 is angled at approximately 59°˜60° from the disk 50. There is a disadvantage of a withdrawal force which is a force used for separating the disk 50 from the clamping device 30 becoming weakened, resultantly causing the disk 50 to easily separate from the clamping device even by a shock force of less than a predetermined level.

The following Table 1 shows withdrawal forces used for separating a disk from a clamping device illustrated in FIG. 1. Table 1 shows an average withdrawal force in which the disk 50 is separated from the clamping device 30 when the disk 50 is supported to the clamping device 30, and a gravitational acceleration speed of a predetermined level is applied for 2 ms. The number of clamping devices 30 at each group is 10, where G is a gravitational constant.

TABLE 1

| GROUP | AVERAGE WITHDRAWAL FORCE |
|---|---|
| First Group | 165G |
| Second Group | 165G |
| Third Group | 165G |
| Fourth Group | 171G |
| Fifth Group | 175G |

Referring to Table 1, each average withdrawal force for separating the disk 50 from the clamping device 30 in the first to third group is 165 G, and each average withdrawal force for separating the disk 50 from the clamping device 30 in the fourth to fifth group is 171 G and 175 G respectively. In a shock experiment relative to the clamping device, a clamping device is considered to be useable if the disk 50 is not separated when a gravitational acceleration speed of 170 G is applied for 2 ms.

However, product reliability of the clamping device 30 of FIG. 1 deteriorated because the disk 50 was detached from approximately 60% of the clamping device. The exemplary embodiment of the present invention to improve the disadvantage will be described hereunder.

FIG. 2 is a cross-sectional view illustrating a spindle motor with a clamping device according to an exemplary embodiment of the present disclosure.

Referring to FIG. 2, a bearing housing 120 having a cylindrical shape is vertically disposed on a base 110. Hereinafter, in description of directions and surfaces of constituent elements including the base 110, a surface and a direction facing a vertical upper side of the base are referred to as ‘upper surface and upper side’ and a surface and a direction facing a lower side of the base are referred to as ‘lower surface and lower side’.

The spindle motor includes the bearing housing 120 which in turn is provided in a cylindrical shape with an open bottom, where a lower end open surface of the bearing housing 120 is sealed by a thrust stopper 125 and a lower surface of the sealed bearing housing 120 is coupled with the base 110.

The bearing housing 120 is press-fitted at an inner periphery by a bearing 130 which is rotatably supported by a lower side of a rotation shaft 140. The bearing housing 120 is coupled with a stator 150 and the rotation shaft 140 is fixed by a rotor 160.

The bearing housing 120 is coupled at an outer periphery with a core 151 and a coil 155 is wound on the core 151. The core 151 and the coil 155 comprise a stator 150. The stator 150 is wrapped by the body of the rotor yoke 161 to face a magnet 165.

Accordingly, when a current is applied to the coil 155, the rotor 160 is rotated by electromagnetic fields formed between the coil 155 and the magnet 165 to rotate the rotation shaft 140. The rotor yoke 161 also serves as a turn table mounted with the disk 50. A felt 170 is coupled to an upper edge of the rotor yoke 161 that prevents the disk 50 from slipping.

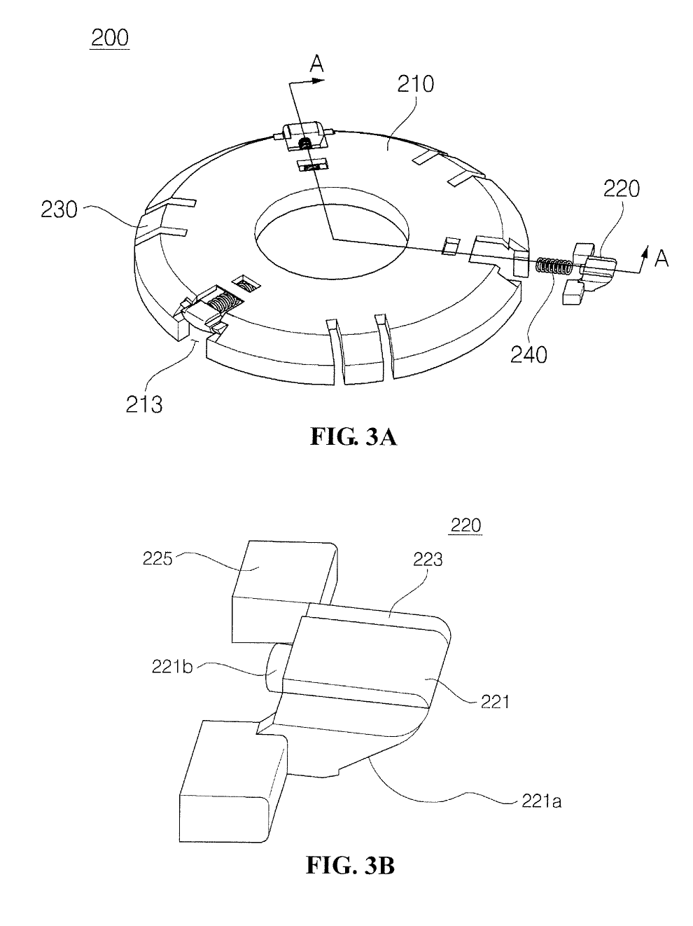

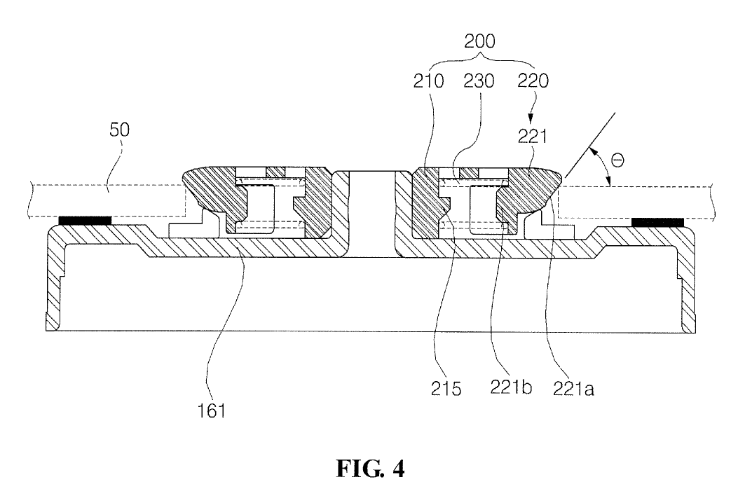

A portion of the rotor yoke 161 coupled to the rotation shaft 140 is coupled with a clamping device 200 supporting the disk 50 mounted on the rotor yoke 161. The clamping device according to the exemplary embodiment of the present invention is provided to securely support the disk 50 by inhibiting the disk 50 mounted on the rotor yoke 161 from being easily disengaged by shock of less than a predetermined strength, the description of which will be given by FIGS. 3a and 4.

FIG. 3a is a perspective view of a clamping device and a rotor yoke illustrated in FIG. 2, FIG. 3b is an enlarged view of arm illustrated in FIG. 3a, and FIG. 4 is a cross-sectional view of line “A-A” of FIG. 3a illustrating a clamping device coupled to a rotor yoke.

The illustrated clamping device 200 may include a case 210, an arm 220, a claw 230 and an elastic member 240.

The case 210 has a shape of a sealed upper surface with an opened cylindrical lower surface. An upper central surface of the case 210 is coupled to a portion of the rotor yoke 161 coupled to the rotation shaft 140 (see FIG. 2), and the opened lower surface of the case 210 faces an upper surface of the rotor yoke 161. A lateral surface of the case 210, which is an outer periphery of the case 210, is insertedly supported by an inner periphery of the disk 50.

The lateral surface of the case 210 is radially formed with a plurality of entry holes 213 about a center of the case 210, and each entry hole 213 is formed with an arm 220 which moves back and forth through radial inner direction and radial outer direction of the case 210. The arm 220 may include a body 221, a guide rail 223 and a disengagement prevention rail 225.

One side of the body 221 is positioned at an outer lateral surface of the case 210, and the other side of the body 221 is positioned inside the body 210 to move back and forth through the entry hole 213.

That is, one distal end surface of the body 221 positioned at the outside of the case 210 is supportively contacted by an inner upper edge of the disk 50, where the body 221 rotatably seesaws and linearly moves toward an inner radial direction of the case 210 at the same time, as the disk 50 is lifted down to allow an inner lower edge of the disk 50 to contact an upper edge of the body 221.

Thus, when the disk 50 is completely inserted into a lateral surface of the case 210 to be mounted on the rotor yoke 161, an inner upper edge of the disk 50 is hitched by a distal end surface of the body 221 to inhibit the disk 50 from being disengaged toward an upper surface of the case 210.

At this time, a distal end surface of the body 221 is formed with an inclination 221a toward a lower surface of the case 210 in a manner of further approaching a center of the case 210 in order to securely support the disk 50. That is, the distal end surface of the body 221 is formed with an inclination 221a toward the opened lower surface of the case 210 in the way of further approaching the center of the case 210.

The guide rail 223 is formed at either side of the body to move back and forth through the entry hole 213, and serves to guide the body 221 for a smooth linear and rotatable movement.

The disengagement prevention rail 225 is extensively formed from the guide rail 223 along a linear movement direction of the arm 220 to be positioned inside the case 210. A distal end of the disengagement prevention rail 225 is brought into contact with a lateral surface of the case 210 to inhibit the arm 220 from being disengaged toward an outer lateral surface of the case 210. It is natural that the body 221, the guide rail 223 and the disengagement prevention rail 225 should move simultaneously.

The claw 230 may radially comprise a structure in an integral plural form with the case 210 about a center of the case 210 and be situated at a lateral surface of the case 210. The claw 230 is formed between the entry holes 213. The claw 230 supports in such a manner that the center of the disk 50 inserted into the case 210 is aligned with the center of the rotation shaft 140.

The elastic member 240 is installed inside the case 210 to elastically support the arm 210 toward the radial exterior direction of the case 210 so that the arm 220 can firmly support the disk 50. One side and the other side of the elastic member 240 are respectively supported by support protrusions 221b, 215 each formed in opposition to the other side of the body 221 of the arm 220 and a lower side of the case 210.

The clamping device is judged as being a normal clamping device if the disk 50 is not withdrawn when applied with a gravitational acceleration speed of 170 G during 2 ms while the disk 50 is mounted on the rotor yoke 161 to be supported by the clamping device 200.

The clamping device 200 according to the present invention is configured in such a manner that an angle (θ) of the inclination 221a of the body 221 is in the range of 52°˜55°. That is, an angle (θ) formed by the inclination 221a of the body 221 and the disk 50 is in the range of 52°˜55°. Then, the body 221 of the arm 220 is increased with a force pressing the disk 50 toward the rotor yoke 161 to improve the withdrawal force, the description of which may be explained by the following Table 2.

TABLE 2

| Inclination Angle of Arm | Group | Average Withdrawal Force |
|---|---|---|
| 52° | 1 | 248G |
| | 2 | 248G |
| | 3 | 234G |
| | 4 | 247G |
| | 5 | 251G |
| 53° | 1 | 240G |
| | 2 | 241G |
| | 3 | 240G |
| | 4 | 239G |
| | 5 | 238G |
| 54° | 1 | 220G |
| | 2 | 219G |
| | 3 | 219G |
| | 4 | 218G |
| | 5 | 221G |
| 55° | 1 | 200G |
| | 2 | 199G |
| | 3 | 202G |
| | 4 | 201G |
| | 5 | 200G |

The Table 2 shows average withdrawal forces in which the disk 50 is separated from the clamping device 200 when the disk 50 is mounted on the rotor yoke 161 to be supported by the clamping device 200 and a gravitational acceleration speed of a predetermined level is applied for 2 ms. The number of the clamping devices 200 in each group is 10, where G is a gravity constant.

As shown in Table 2, the average withdrawal forces of the clamping device 200 according to the exemplary embodiment of the present invention were all more than 170 G, i.e., 247 G-251 G, 238 G-254 G, 218 G-221 G and 199 G-202 G, respectively. Thus, the clamping device according to the exemplary embodiment of the present invention is judged as being an excellent because the disk 50 was not withdrawn when applied with a gravitational acceleration speed of 170 G for 2 ms.

The Table 3 below shows average withdrawal forces when angles of the inclination of the body 221 at the arm 220 are given at 52° and 55° respectively, where the number of the clamping devices 200 in each group is 10, and G is a gravity constant. When an angle of the inclination 221a was at 51°, the withdrawal forces were given as 287 G˜297 g. But the inclination was too gentle, which makes it difficult to support the disk 50. In case of the angle being at 56°, the withdrawal force was in the vicinity of 170 G, which is a judging value as to whether clamping device is acceptable or not.

Thus, the clamping device according to the exemplary embodiment of the present invention is made to form the angle formed by the inclination 221a of the body 221 at the arm 220 and the disk 50 at 52°˜55°.

TABLE 3

| Inclination Angle of Arm | Group | Average Withdrawal Force |
|---|---|---|
| 51° | 1 | 287G |
| | 2 | 295G |
| | 3 | 290G |
| | 4 | 293G |
| | 5 | 297G |
| 56° | 1 | 178G |
| | 2 | 180G |
| | 3 | 180G |
| | 4 | 181G |
| | 5 | 178G |

The clamping device of a spindle motor according to the exemplary embodiment of the present invention is so formed as to allow an inclination supporting a disk by being in contact with an inner upper circumferential edge of the disk mounted on a rotor yoke of a body at an arm to form an angle of 52°˜55°, whereby a force of the arm pressing the disk toward the rotor yoke is increased to improve the withdrawal force. Thus, the disk is not separated from the clamping device by a shock of less than a predetermined size, thereby enhancing the reliability of product.

Any reference in this specification to “one embodiment,” “an embodiment,” “exemplary embodiment,” etc., means that a particular feature, structure, or characteristic described in connection with the embodiment is included in at least one embodiment of the disclosure. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with others of the embodiments.

Although embodiments have been described with reference to a number of illustrative embodiments thereof, it should be understood that numerous other modifications and embodiments can be devised by those skilled in the art that will fall within the spirit and scope of the principles of this invention. More particularly, various variations and modifications are possible in the component parts and/or arrangements of the subject combination arrangement within the scope of the disclosure, the drawing and the appended claims. In addition to variations and modifications in the component parts and/or arrangements, alternative uses will also be apparent to those skilled in the art.

What is claimed is:

1. A clamping device of a spindle motor comprising: a case rotating with a rotation shaft of a spindle motor; a plurality of arms provided at the case for supporting a disk and clamping the disk on the case, and having an inclination at a portion facing the disk; and an elastic member installed inside the case for elastically supporting the arms toward an radial exterior direction of the case, wherein an angle formed by an inclination of the arm and the disk is in the range of 52°˜55°.

2. The clamping device of claim 1, wherein the inclination of the arm supports the disk by being in contact with an inner circumferential edge of the disk, and is inclined in the manner of further approaching the rotation shaft so as to press the disk toward the case.

3. The clamping device of claim 1, wherein an central surface of the case is fixed to the rotor yoke coupled to the rotation shaft, a lateral surface of the case is radially formed with a plurality of entry holes, and the arm formed at the entry hole to elastically move back and forth through inner and outer lateral surfaces of the case.

4. The clamping device of claim 1, wherein the arm comprises: a body that moves back and forth in and out of the case; a guide rail formed at either side of the body for guiding the body in linear and rotatable movements; and a disengagement prevention rail extensively formed from the guide rail to inhibit the body from disengaging toward an outer lateral surface of the case.

5. The clamping device of claim 1, wherein a plurality of claws is alternatively arranged with arm along the outer periphery of the case and supportively contacts an inner periphery of the disk in such a manner that the center of the disk is aligned with that of the rotation shaft.

6. A spindle motor comprising: a rotation shaft; a stator arranged about the rotation shaft and having a core wound with coil; a rotor yoke rotating around the core and whose center is press-fitted into the rotation shaft for mounting a disk thereon and for rotating by wrapping the disk; and a clamping device provided with a plurality of arms for clamping the disk and supporting the disk mounted on the rotor yoke, wherein the arm is provided with an inclination having an angle as large as 52°˜55° from the disk.
